(19) United States
(12) Patent Application Publication
(10) Pub. No.: US 2008/0233931 A1
(43) Pub. Date: Sep. 25, 2008

(54) Location Service Method and System

(76) Inventor: Dong-Hee Shim, Seoul (KR)

Correspondence Address: BIRCH STEWART KOLASCH & BIRCH, PO BOX 747, FALLS CHURCH, VA, 22040-0747, US

(21) Appl. No.: 12/067,139

(22) PCT Filed: Sep. 18, 2006
(86) PCT No.: PCT/KR2006/003712

§ 371 Date: Mar. 17, 2008

Related U.S. Application Data
(60) Provisional application No. 60/724,283, filed on Oct. 7, 2005.
(60) Provisional application No. 60/757,032, filed on Jan. 9, 2006.

(30) Foreign Application Priority Data
May 29, 2006 (KR) 10-2006-0048395

(51) Int. Cl. H04Q 7/38

(52) U.S. Cl. 455/414.3

(57) ABSTRACT

A location service method and system, the location service method implemented by receiving an emergency positioning request with respect to a target terminal using a location service system based upon a user plane, and providing the target terminal with connection information of a network entity which is to perform the emergency positioning for the target terminal in response to the request, wherein the target terminal can request the network entity to initiate the emergency positioning using the connection information of the network entity, the network entity can calculate location information regarding the target terminal by a consecutive message exchange with the target terminal according to the emergency positioning initiation request, and the network entity sends the corresponding calculated location information to the target terminal and an emergency condition processing center.

### TECHNICAL FIELD

The present invention relates to a location service method and system, and more particularly, to a location service method and system capable of efficiently providing an emergency location service based upon a Secure User Plane Location (SUPL).

### BACKGROUND ART

In general, a location service in a mobile communication refers to a communication network service for detecting location information related to a target terminal and sending the location information to an entity on a network requiring the location information. Such location service can allow users to be provided with various additional services, such as a traffic information service, a location information service, a weather information service, a car navigation system, an emergency management service, and the like.

A system for supporting such location services may differently be implemented and operated based upon structures and characteristics of a network. However, researches have actively been made to standardize location service related communication protocols and thus to commonly adapt them to different networks, one example of which may be a Secure User Plane Location (SUPL).

The SUPL refers to a user plane based communication protocol to basically provide location services through a user plane. For example, the SUPL uses a user plane data bearer to transfer location supplementary information such as an Assisted-Global Positioning System (A-GPS) and to deliver a positioning technology related protocol between a mobile terminal and a network.

The SUPL based location service may be provided through a SUPL network which may comprise a SUPL agent, a SUPL Enabled Terminal (SET) which is supportable for the SUPL service, and a SUPL Location Platform (SLP).

Here, the SUPL agent denotes a service access point for accessing network resources to obtain location information. The SUPL agent may exist in the SET, in some cases.

The SET denotes a terminal communicatable with the SUPL network. For example, the SET may denote a User Equipment (UE) in a Universal Mobile Telecommunication System (UMTS), a Global System for Mobile Communication (GPS), an Inter Standard-95 (IS-95), or mobile communications terminals including laptop computers or Personal Digital Assistance (PDAs) having a SET function. The SET is interworked with the SUPL network through a user plane bearer to support procedures defined in the SUPL. In addition, among several SETs, a SET which is targeted for a current positioning may be referred to as a target SET.

The SLP is a network entity for managing the SUPL service and determining a location of a target SET. The SLP may be configured with a SUPL Positioning Center (SPC) and a SUPL Location Center (SLC). The SPC is an entity to calculate an actual location of the SET, and the SLC is an entity to manage other functions of the SLP, for example, a roaming function, a resource managing function, an the like, except the location calculating (positioning) function performed by the SPC.

The SET can be connected to the SPC via the SLC or directly connected thereto for communication. A connection mode that the SET is connected to the SPC via the SLC is referred to as a proxy mode, while a connection mode that the SET is directly connected to the SPC is referred to as a non-proxy mode. The proxy mode or non-proxy mode may enable a message exchange between the SET and the SPC when being connected and allow the SPC to perform the SET positioning.

Meanwhile, in characteristics of a location service based upon a location of a mobile terminal, it is important in the aspect of a service efficiency whether an emergency call originated by a user to immediately request location information is fast processed. That is, when a user desires to immediately know his current location due to a disaster or car accident being occurred, the user should immediately recognize his current location by an emergency call service. However, if the emergency call is not processed immediately (i.e., processed with delay), the service efficiency may greatly be lowered.

However, a current communication protocol based upon a user plane does not consider in detail an emergency call, and also does not provide any structure of a SUPL network for establishing an emergency call and a calling procedure in the corresponding structure. For example, regarding the current SUPL based location service processing procedure, for a SET initiated case that a service is started when requested by a SET, the SET always first accesses a SLP of a home network in which the SET itself has been registered thus to initiate the corresponding location service. In this case, when the SET requests an emergency call, there is not provided any definition for how to process the corresponding request.

Furthermore, when the SET has roamed to another network other than its home network, it is the fastest way to directly process the emergency call on a network where the SET is currently located. However, regarding the current SUPL based location service processing procedure, the SET must first access the SLP of its home network for requesting its location calculation (i.e., positioning). Accordingly, the processing can disadvantageously be delayed by a process of transferring the corresponding request to an area in which the SET is currently located via the SLP of the home network.

Thus, it may be difficult, depending on the current SUPL network structure and the location service procedure according thereto, to appropriately provide an emergency call service requested from a network in which the SET is currently located. That is, when considered in conjunction with the characteristics, the emergency call service should be supported even when a user has (SUPL) roamed to another operator's network or when an emergency condition has occurred on an operator's network where a roaming agreement does not exist. However, any solution has not provided yet.

### DISCLOSURE OF THE INVENTION

Therefore, it is an object of the present invention to provide a location service method capable of efficiently providing an emergency location calculating (i.e., emergency positioning) service using a user plane based network.

Another object of the present invention is to provide a location service system based upon a user plane capable of facilitating a processing of an emergency positioning request with respect to a target terminal.

To achieve these objects, there is provided a location service method using a user plane based location service system comprising: receiving an emergency positioning request message from a target terminal; and sending a message to the target terminal in response to the received emergency location positioning message, the message including address information on a network entity which is to perform the emergency positioning for the target terminal and connection mode information.

The location service method may further comprise: calculating location information related to the target terminal by a consecutive message exchange between the network entity and the target terminal when the network entity receives a message for requesting a positioning initiation from the target terminal. Also, the location service method may further comprise: sending the calculated location information, by the network entity, to either the target terminal or an emergency condition processing center located at a position close to the target terminal.

The address information may be either an address of Emergency SUPL Location Platform (E-SLP) address or an address of Emergency SUPL Positioning Center (E-SPC) address. Here, the E-SLP is a network entity which manages an emergency location service and determines a location of a target SET. The E-SLP may be configured with an E-SPC and an E-SLC. Here, the E-SPC is an entity to calculate an actual location of the target SET, and the E-SLC is an entity to manage other functions of the SLP, for example, a roaming function, a resource managing function, and the like, except the location calculating (positioning) function performed by the SPC.

The connection mode information denotes information for identifying a non-proxy mode in which the target terminal is directly communicatable with the E-SPC, and a proxy mode in which the target terminal is communicatable with the E-SPC via the E-SLC within the E-SLP.

When the connection mode information indicates the non-proxy mode, the address information is the E-SPC address, while being the E-SLP address for the proxy mode.

According to an embodiment of the present invention, a location service method using a SUPL based location service system may comprise: receiving, in an E-SLP, a SUPL START message including emergency call indication information of a target terminal; and sending a SUPL RESPONSE message in response to the SUPL START message sent from the E-SLP, the SUPL RESPONSE message including connection information on a network entity which is to perform the emergency positioning for the target terminal.

Here, the SUPL START message received in the E-SLP may be a message which is generated by the target terminal, then first received by a Home-SUPL Location Platform (H-SLP), and finally sent to the E-SLP.

In this case, receiving the SUPL START message may comprise: receiving in the H-SLP the SUPL START message sent from the target terminal; retrieving routing information of the target terminal to determine whether the target terminal is currently (SUPL) roaming; sending the received SUPL START message to a Visited SUPL Location Platform (V-SLP) when it is determined the target terminal is roaming, and sending the received SUPL START message to an E-SLP of a home network when it is determined the target terminal is not roaming.

Also, when the target terminal is not roaming, sending the SUPL RESPONSE message may include: sending the SUPL RESPONSE message from the E-SLP of the home network to the H-SLP; and sending the sent SUPL RESPONSE message from the H-SLP to the target terminal.

The V-SLP may send the sent SUPL START message to an E-SLP of a visited network. Here, sending the SUPL RESPONSE message may comprise: sending the SUPL RESPONSE message from the E-SLP of the visited network to the V-SLP; sending the sent SUPL RESPONSE message from the V-SLP to the H-SLP; and sending the sent SUPL RESPONSE message from the H-SLP to the target terminal.

Meanwhile, the SUPL START message received in the E-SLP may be a message directly sent from the target terminal. Here, the location service method may further comprise: retrieving, by the E-SLP, routing information on the target terminal to determine the H-SLP when receiving the SUPL START message from the target terminal; sending, by the E-SLP, the received SUPL START message to the determined H-SLP to inform the H-SLP of emergency call information of the target terminal; and sending from the H-SLP to the E-SLP the SUPL RESPONSE message indicating the successful reception of the SUPL START message. Here, the H-SLP may perform a target terminal authentication by the reception of the SUPL START message.

The SUPL START message and the SUPL RESPONSE message sent among the E-SLP, H-SLP and V-SLP may be sent in a format of a Roaming Location Protocol (RLP) message.

The connection information may include address information related to the network entity and connection mode information. Here, the address information related to the network entity may be either an address of the E-SLP or an address of an E-SPC provided in the E-SLP. Also, the address information related to the network entity may be either an address of a SLP or an address of a SPC provided in the SLP when there exists the SLP located closer to the target terminal as compared with the E-SLP. The connection mode information may be information for identifying a non-proxy mode and a proxy mode.

The location service method may further comprise: calculating location information regarding the target terminal by a consecutive message exchange between the network entity and the target terminal when the network entity receives from the target terminal a SUPL POS INIT message for requesting the emergency positioning initiation. Furthermore, the location service method may further comprise: sending SUPL END message including the calculated location information from the network entity to the target terminal when completely calculating the location information; and sending an emergency message including the calculated location information from the network entity to an emergency condition processing center located close to the target terminal. Here, the emergency message may be a MLP (Mobile Location Protocol) EMEREP (Emergency Location Report) message.

When the network entity is different from the E-SLP, the network entity sends the SUPL END message to the E-SLP.

The emergency call indication information may be information for identifying whether the SUPL START message is a message related to an emergency call or a message related to a general location service request. The emergency call indication information is inserted in a particular field of the SUPL START message. The emergency call indication information may be inserted in the field in an active/not-active format. Also, the SUPL START message may be divided into the message related to the emergency call or the message related to the general location service request depending on whether there is a value inserted in the field.

The SUPL START message may include information on a cell to which the target terminal belongs and required Quality of Service (QoS) related information regarding location information. In this case, any one of the E-SLP and the SLP sending the SUPL START message can convert the cell information into the location information. Here, the E-SLP can send the converted location information to either the target terminal or the emergency condition processing center located close to the target terminal when the converted location information satisfies the QoS.

Meanwhile, according to an embodiment of the present invention, a location service method using a terminal which can support a SUPL service may comprise: obtaining address information on an E-SLP to which an emergency call is to be sent; sending a SUPL START message including emergency call indication information to the E-SLP using the address information obtained; receiving from the E-SLP a SUPL RESPONSE message including connection information related to a network entity which is to perform an emergency positioning; and connecting to the network entity using the connection information and sending a positioning related message requested by the network entity.

The terminal may obtain the address information by querying the address of the E-SLP to a Domain Name System (DNS) server. Here, the terminal may query a Dynamic Host Configuration Protocol (DHCP) server thus to obtain the address of the DNS server.

Furthermore, the terminal may obtain the address information which has previously been stored in the terminal in a provisioning manner. Here, the address information stored in the terminal may be stored by adapting a method of storing the address information at a time point of manufacturing the terminal, a method of updating the address information from an external entity through a communication network, a method of storing address information in a process that the terminal is subscribed in a service, and the like.

The terminal may generate the address information using predetermined code information according to a fixed rule. Also, the address information may be generated using specific information of the terminal according to a fixed rule. Here, the specific information may be an IMSI (International Mobile Subscriber Identity) value existing in a UICC (Universal Integrated Circuit Card) of the terminal. Here, obtaining the address information may comprise: reading the IMSI value out of the UICC; extracting certain bits from the IMSI value to divide them into a Mobile Country Code (MCC) value and a Mobile Network Code (MNC) value; and configuring a domain address of the E-SLP using the divided MCC value and MNC value according to a fixed rule. Also, obtaining the address information may further comprise adding identification information indicating an entity for an emergency call to the domain address configured.

According to an embodiment of the present invention, a location service method using a SUPL based location service system may comprise: receiving an emergency positioning request for a target terminal from a SUPL agent; sending the received emergency positioning request to an E-SLP; and sending a SUPL INIT message from the E-SLP to the target terminal, the SUPL INIT message including connection information for a network entity which is to perform the emergency positioning for the target terminal.

The SUPL agent may exist within an emergency condition processing center. The emergency positioning request sent from the SUPL agent may be received by a Requesting SLP (R-SLP). Also, the emergency positioning request sent from the SUPL agent may be an MLP EME_LIR (Emergency Location Immediate Request) message.

Sending the emergency positioning request may comprise: retrieving routing information on the target terminal to identify whether the target terminal is currently (SUPL) roaming; sending the emergency positioning request to an E-SLP of a visited network to which the target terminal belongs when it is identified the target terminal is roaming, and sending the emergency positioning request to an E-SLP of a home network in which the target terminal has been registered when it is determined the target terminal is not roaming.

The R-SLP can access Home Location Register (HLR) and Home Subscriber Server (HSS) of the home network to identify the roaming state of the target terminal. Also, the R-SLP can retrieve at least one of the routing information of the target terminal and a lookup table of the target terminal via an internal communication with the H-SLP. The emergency positioning request sent from the R-SLP to the E-SLP may be a RLP ERLIR (Emergency Roaming Location Immediate Request) message.

The E-SLP sends the emergency positioning request sent from the R-SLP to the H-SLP, which then sends a response message in response to the emergency positioning request to the E-SLP. Here, the H-SLP receives the emergency positioning request sent from the R-SLP and then performs a target terminal authentication.

The emergency positioning request sent from the E-SLP to the H-SLP may be either a SUPL START message in a format of a RLR ERLIR message or a SUPL START message in a format of a RLP SSRLIR (Standard SUPL Roaming Location Immediate Request) message. Also, the response message sent from the H-SLP to the E-SLP may be either a SUPL RESPONSE message in a format of a RLR ERLIA (Emergency Roaming Location Immediate Answer) or a SUPL RESPONSE message in a format of a RLP SSRLIA (Standard SUPL Roaming Location Immediate Answer) message.

The connection information regarding the network entity may include address information related to the network entity and connection mode information. Here, the address information related to the network entity may be either an address of the E-SLP or an address of an E-SPC provided in the E-SLP. Also, the address information related to the network entity may be either an address of a SLP or an address of a SPC provided in the SLP when there exists the SLP which is located closer to the target terminal, as compared with the E-SLP. The connection mode information may be information for allowing an identification between a non-proxy mode and a proxy mode.

Furthermore, the location service method may further comprise calculating location information related to the target terminal by a consecutive message exchange between the network entity and the target terminal when receiving from the target terminal a SUPL POS INIT message for requesting an initiation of the emergency positioning. Also, the location service method may further comprise: sending a SUPL END message including the calculated location information from the network entity to the target terminal when completely calculating the location information; and sending an emergency message including the calculated location information from the network entity to an emergency condition processing center located close to the target terminal.

Here, the location service method may further comprise sending the SUPL END message from the network entity to the E-SLP when the network entity is different from the E-SLP. The E-SLP may send the sent SUPL END message to the H-SLP.

Sending the emergency message may comprise: sending a RLP ERLIA message including the calculated location information from the network entity to the R-SLP; converting by the R-SLP the RLP ERLIA message received into a MLP EME_LIA (Emergency Location Immediate Answer) message to send it to the SUPL agent.

According to an embodiment of the present invention, a location service system may comprise: at least one SLP for sending an emergency positioning request message by detecting a network to which a target terminal belongs when receiving the emergency positioning request with respect to a target terminal; and an E-SLP for providing the target terminal with connection information required for the positioning for the target terminal, in response to the emergency positioning request message sent from the at least one SLP.

Here, the E-SLP can have a standardized specific address. The target terminal can use an address of the E-SLP to send a SUPL START message including emergency call indication information to the E-SLP. The SLP and E-SLP can be communicated with each other using RLP messages. Also, the E-SLP may exist in the SLP.

### BRIEF DESCRIPTION OF THE DRAWINGS

FIG. 1 is a block diagram illustrating a schematic construction of a Secure User Plane Location (SUPL) based network to implement a location service method in accordance with a preferred embodiment of the present invention.

FIG. 2 is a message flowchart illustrating a location service method in accordance with a first embodiment of the present invention.

FIG. 3 is a message flowchart illustrating a location service method in accordance with a second embodiment of the present invention.

FIG. 4 is a message flowchart illustrating a location service method in accordance with a third embodiment of the present invention.

FIG. 5 is a flowchart illustrating a process in which a target SET obtains an E-SLP address by a DNS query.

FIG. 6 is an exemplary view illustrating a typical construction of a International Mobile Subscriber Identity (IMSI).

FIG. 7 is a message flowchart illustrating a location service method in accordance with a fourth embodiment of the present invention.

FIG. 8 is a message flowchart illustrating a location service method in accordance with a fifth embodiment of the present invention.

### MODES FOR CARRYING OUT THE PREFERRED EMBODIMENTS

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

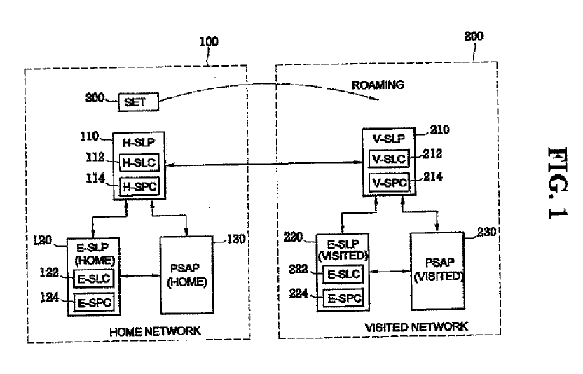

FIG. 1 is a block diagram illustrating a schematic construction of a Secure User Plane Location (SUPL) based network to implement a location service method in accordance with a preferred embodiment of the present invention.

As illustrated in FIG. 1, a SET (i.e., a mobile terminal) 300 may be located in a home network 100 in which the SET has originally been registered, or be located in another network in a roaming manner other than the home network 100. Thus, when the SET 300 is located in another area other than the home network 100, the network in the area to which the SET 300 currently belongs is referred to as a visited network 200.

Each of the networks 100 and 200 may include SLPs 110 and 210, E-SLPs (Emergency-SLPs) 120 and 220 and PSAPs (Public Safety Answer Points) 130 and 230 all of which are interworked with one another via specific protocols.

Here, the SLP 110 of the home network 100 is referred to as a H-SLP 110, while the SLP 210 of the visited network 200 is referred to as a V-SLP 210. Also, SPC 114 and SLC 112 included in the H-SLP 110 are referred to as H-SPC 114 and H-SLC 112, respectively. In the same manner, SPC 214 and SLC 212 included in the V-SLP 210 are referred to as V-SPC 214 and V-SLC 212, respectively.

Each of the E-SLPs 120 and 220 calculates location information regarding the SET 300 by being connected to the SET 300 through particular message sending procedures when the SET 300 originates an emergency call, and then performs an emergency positioning function for notifying the SET 300 or PSAPs 130 and 230 of the calculated location information. That is, the E-SLPs 120 and 220 may be considered as SLPs for the emergency call.

The E-SLPs 120 and 220 may include E-SPCs (Emergency-SPCs) 124 and 224 and E-SLCs (Emergency-SPC) 122 and 222. Here, each of the E-SPCs 124 and 224 may perform a function for calculating an actual location of the SET 300 for the emergency call, and each of the E-SLCs 122 and 222 may perform other functions of the E-SLPs 120 and 220, for example, resource management except the positioning function performed by the SPCs 124 and 224.

The E-SLPs 120 and 220 may separately exist in every network, or be independent of a network. That is, one E-SLP may cover areas of plural networks. For example, in FIG. 1, the E-SLPs 120 and 220 are illustrated separately in the home network 100 and the visited network 200. However, one E-SLP may perform an emergency positioning for every SET located within both the area of the home network 100 and the area of the visited network 200 according to operational environments. Preferably, there may exist at least one E-SLP which can process the emergency positioning with respect to an emergency call originated by the SETs located within each network area. That is, regardless of a SET being located in any network, there must exist at least one E-SLP which can perform the emergency positioning for the SET.

Furthermore, the E-SLPs 120 and 220 may be positioned in the SLPs 110 and 210 of the corresponding networks 100 and 200. That is, the H-SLP 110 or the V-SLP 210 may have the same function as the E-SLPs 120 and 220 do. Accordingly, in this case, the E-SLPs 120 and 220 may not separately be required. Here, when the E-SLPs 120 and 220 are configured with E-SPCs 124 and 224 and E-SLCs 122 and 222, functions of the E-SPCs 124 and 224 may be performed by the SPCs 114 and 214, and the functions of the E-SLCs 122 and 222 may be performed by the SLCs 112 and 212.

Each of the E-SLPs 120 and 220 may have a standardized specific address, for example, a domain address such as “emergency.slp@lge.com”, or the like. The address of the E-SLP may be pre-stored in the SET 300 in a provisioning manner, detected by a DNS query, or generated in the SET 300 based upon a designated rule. Here, the SET 300 can use the address of the E-SLP to directly request an emergency call from the E-SLP 120 or 220 which manages a network 100 or 200 to which the SET belongs, operation of which will later be explained in detail.

The PSAPs 130 and 230 perform a function for processing an emergency condition occurred to a user by receiving location information on the SET 300 from the E-SLPs 120 and 220. For example, the PSAPs 130 and 230 may correspond to servers of a police office, a fire station, emergency center in a hospital, and the like. Such PSAPs 130 and 230 may be independent of their networks as similar as the aforementioned E-SLPs 120 and 220. Namely, one PSAP may cover areas of plural networks, and also plural PSAPs may exist within one network.

Meanwhile, communications among the H-SLP, V-SLP, E-SLPs, and PSAPs may be implemented by messages using various protocols. For example, embodiments to be described herebelow use a Roaming Location Protocol (RLP) and a Mobile Location Protocol (MLP). However, the present invention may not be limited thereto, and other various protocols in addition to the RLP and MLP can be used.

As aforementioned, the construction of the SUPL network for implementing the location service method according to preferred embodiments of the present invention has been explained. The location service system for providing an emergency positioning (i.e., location calculation) service with respect to the target SET 300 in the SUPL network may be provided with the H-SLP 110, the V-SLP 210, the E-SLPs 120 and 220, and the like. However, such construction of entities may depend on whether the target SET 300 is roaming.

Hereinafter, explanation will be given of a method for processing an emergency call according to preferred embodiments of the present invention based upon the construction of the SUPL network.

### First Embodiment

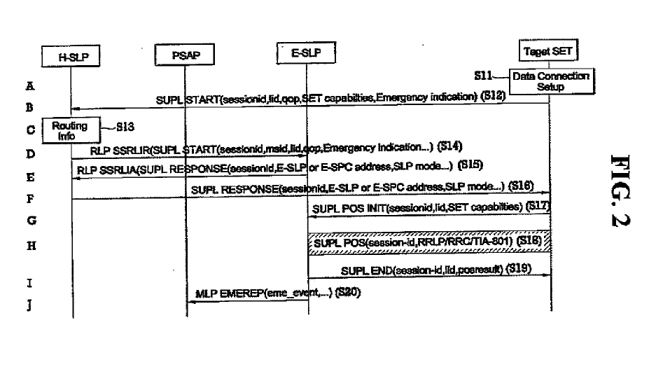

FIG. 2 is a message flowchart illustrating a location service method in accordance with a first embodiment of the present invention, which illustrates an emergency call processing procedure when a SET is in a non-roaming state and a connection mode is a proxy mode.

As illustrated in FIG. 2, since a visited network does not exist in a non-roaming case, target SET, H-SLP and E-SLP take part in an emergency positioning (location calculation) process. That is, a location service system for providing an emergency positioning service to the target SET may include the H-SLP and the E-SLP which performs the emergency positioning of a home network. Here, the target SET becomes a subject to request a location service due to an occurrence of an emergency condition, and simultaneously is targeted for positioning. In this SET initiated case, a SUPL agent may exist within the SET.

First, when any data connection has not been set between the target SET and a network before requesting an emergency call, the target SET requests a data connection from a packet switches network or a circuit switched network to perform the data connection setup (S11). Here, the network may be a 3GPP (3G Partnership Project, asynchronous) network or 3GPP2 (3G Partnership Project-2, synchronous) network.

Upon completely setting the data connection, the target SET sends a SUPL START message including emergency call indication information to the H-SLP to request an emergency positioning therefrom (S12). Here, the SUPL START message may further include a session ID (session id), a location ID (lid), required quality of service (QoS) related information (qop), SET capabilities related information, emergency call indication information (Emergency indication), and the like.

The session ID is an identifier information indicating a SUPL session initiated by the emergency call of the target SET. The location ID may denote an ID of a cell in which the target SET is currently located, namely, a base station ID. The use of the location ID can allow an approximate detection of the current location of the target SET. The quality of service (QoS) related information (qop) denotes information related to a quality of location information requested by the emergency call, example of which may be resolution information related to the location information requested, or the like.

The SET capabilities related information may include a positioning method supported by the target SET and protocol information usable for the positioning. Here, the positioning method may include a SET assisted A-GPS, a SET based A-GPS, a Cell-ID method, and the like. For the positioning are used protocols such as RRLP (Radio Resource Location service Protocol) of GPRS (General Packet Radio Service), RRC (Radio Resource Control) of WCDMA (Wideband Code Division Multiple Access), TIA-801 of CDMA (Code Division Multiple Access), etc.

The emergency call indication information is information indicating that the SUPL START message sent is a message related to an emergency call. The emergency call indication information may be inserted by adding a field with certain bits to a typical SUPL. START message or by designating a field remaining without being used.

Here, the emergency call indication information inserted in the field may be inserted in various manners in an active/non-active format according to whether or not the corresponding SUPL message is related to an emergency call. For example, for an emergency call request, an active value (i.e., “Active”, “1” or “True”) is inserted in the field. For a general commercial location service, on the other hand, a Not-active value (i.e., “Not-active”, “0” or “False”) is inserted in the field. Accordingly, it is possible to identify whether the corresponding SUPL message is a message related to the emergency call or related to a general location service request.

Also, the emergency call indication information may inserted in various formats indicating the emergency call, for example, in a format of “emergency_event”.

In another manner, for the emergency call service, a certain value is inserted in the field, while remaining empty for the general commercial location service. Accordingly, it is allowed to identify whether the corresponding SUPL message is a message related to the emergency call. Here, the emergency call related message may have a priority higher than that of the general commercial location service related message.

When sending the SUPL START message to the H-SLP, the H-SLP retrieves routing information of the target SET to determine whether the target SET is roaming or not (S13). In this regard, the H-SLP manages the routing information in order to allow the determination of the roaming state of SETs registered in the H-SLP itself. The H-SLP also manages a SET lookup table for determining whether SETs registered therein can support the SUPL function.

The first embodiment considers the case that the SET is in the non-roaming state. Accordingly, the H-SLP can identify the target SET is currently in the non-roaming state, namely, the target SET is located in the area of the home network. Thus, the H-SLP forwards the sent SUPL START message to the E-SLP via the RLP (Roaming Location Protocol) (S14). That is, the SUPL START message is sent to the E-SLP in the format of a RLP SSRLIR (Standard SUPL Roaming Location Immediate Request) message.

Afterwards, the E-SLP sends to the H-SLP a SUPL RESPONSE message including its address information in a format of a RLP SSRLIA (Standard SUPL Roaming Location Immediate Answer) message, in response to the RLP SSRLIR message sent (S15).

The address information may be an address connectable to the E-SLP, for example, an IP address or URL address of the E-SLP. Also, for a non-proxy mode, the address information may be an address of an E-SPC.

The SUPL RESPONSE message may include a session ID (session id) and connection mode information (SLP mode) in addition to the address information related to the E-SLP. Here, the connection mode information may denote a parameter for discriminating the non-proxy mode and the proxy mode. Also, the SUPL RESPONE message may further include a positioning method supportable by the E-SLP.

The H-SLP receives the SUPL RESPONSE message in the RLP SSRLIA message format sent from the E-SLP, and then sends the SUPL RESPONSE message to the target SET (S16). Therefore, the target SET can receive the SUPL RESPONSE message.

The target SET sends a SUPL POS INIT message for requesting an initiation of a positioning procedure to the E-SLP by using the address of the E-SLP sent by being included in the SUPL RESPONSE message, thereby initiating an actual positioning related procedure (S17). Here, if in the non-proxy mode, the target SET can initiate the positioning related procedure by sending the SUPL POS INIT message to the E-SPC.

The SUPL POS INIT message may include a session ID (session id), a location ID (lid) and SET capabilities related information (SET capabilities). The SET capabilities related information, as aforementioned, may include a positioning method supported by the target SET (e.g., the SET assisted A-GPS or SET based A-GPS), protocol information usable for positioning (e.g., RRLP, RRC or TIA-801), etc.

The E-SLP determines positioning method and related protocol to use for the positioning of the target SET based upon the SET capabilities included in the SUPL POS INIT message received. The E-SLP then consecutively exchanges message with the target SET for the positioning to thereby calculate a location of the target SET (S18).

Upon completely calculating the location information with respect to the target SET, the E-SLP sends the calculated location information (pos result) with respect to the target SET to the target SET using a SUPL END message to inform the termination of the SUPL procedure (S19). The SUPL END message may include a session ID as well as the calculated location information for the target SET.

Afterwards, the E-SLP sends emergency event information (eme_event) including the calculated location information for the target SET to the PSAP via a MLP (Mobile Location Protocol) to request the PSAP to process an emergency condition (S20). That is, the E-SLP sends a MLP EMEREP (Emergency Location Report) message to the PSAP. Here, the MLP EMEREP message may include event trigger information as well as the location information for the target SET.

The event trigger information is information for identifying whether a currently-sent emergency event information is a firstly-sent information or a lastly-sent information with respect to the corresponding emergency event. The positioning for the specific target SET may consecutively be performed based upon time, and the emergency event information sent to the PSAP may also be sent in plurality according to the lapse of time. Accordingly, whether the emergency event information sent to the PSAP is the firstly-sent information or the lastly-sent information needs to be identified, which can be identified using the event trigger information.

An example of the MLP E MEREP message may be represented as follows.

```
<emerep ver=“3.0.0”>
  <eme_event eme_trigger=“EME_ORG”>
    <eme_pos>
      <msid>461011678298</msid>
      <pd>
                <time utc_off=“+0300”>20020623010003</time>
                <shape>
        <CircularArea srsName=“www.epsg.org#4326”>
            <coord>
                    <X>30 27 45.3N</X>
                  <Y>45 25 50.78E</Y>
        </coord>
      <radius>15</radius>
          </CircularArea>
      </shape>
  </pd>
    </eme_pos>
  </eme_event>
</emerep>
```

Referring to the exemplary MLP EMEREP message, the event trigger information eme_trigger can be used to identify whether the emergency event information eve_event is origination information or release information. The exemplary emergency event information eme_event can be identified as the origination information because the event trigger value is “EME_ORG” (the event trigger value may be indicated as “EME_REL” for the release information).

Here, the origination information denotes information which is a firstly sent among emergency events generated by the request from the target SET, and the release information denotes information which is lastly sent. Thus, the exemplary emergency event information can be determined to be the firstly-sent emergency event information, which means information related to the corresponding emergency event can further be received. On the other hand, the reception of the release information means termination of the corresponding emergency event. If a sent emergency event is neither the origination information nor the release information, the event trigger information may be omitted.

Furthermore, the emergency event information eme_event may include location information eme_pos regarding the target SET. Referring to the exemplary MLP EMEREP message, it can be noted that the emergency event information has included the location information eme_pos regarding the target SET which contains a target SET id (ms_id), a circular area value in which the target SET is located, X/Y coordinate values of the target SET and a radius.

The H-SLP or E-SLP can approximately calculate a current location of the target SET using the location ID included in the SUPL START message sent from the target SET. When the calculated value satisfies the quality of service (QoS) related information qop, the positioning step (S18) performed by a consecutive message exchange between the E-SLP and the target SET can be omitted.

For example, after sending the SUPL START message by the target SET (S12), the H-SLP approximately calculates the current location of the target SET using the location ID included in the SUPL START message to thereafter send it to the E-SLP. The H-SLP then terminates the SUPL session for the emergency positioning. The E-SLP then inserts the location value sent from the H-SLP in the MLP EMEREP message to send it to the PSAP in order to request the PSAP to process the emergency condition.

In another method, the H-SLP forwards the SUPL START message to the E-SLP using the RLP SSRLIR message. The E-SLP then approximately calculates a current location value of the target SET using the location ID included in the SUPL START message. In this case, the E-SLP includes the calculated location value in the RLP SSRLIA message which is used to inform the session termination (end) to send it to the H-SLP. The E-SLP also sends the MLP EMEREP message including the calculated location value to the PSAP.

As described above, in the first embodiment of the present invention, the location service method for the emergency call in the case that the target SET is in the non-roaming state and the connection mode is the proxy mode has been explained. However, the emergency call may be more requested when a user visits different areas, namely, the user is in a roaming state. Therefore, according to second and third embodiments herebelow, a location service method based upon a SUPL when the target SET is in a roaming state will be explained.

### Second Embodiment

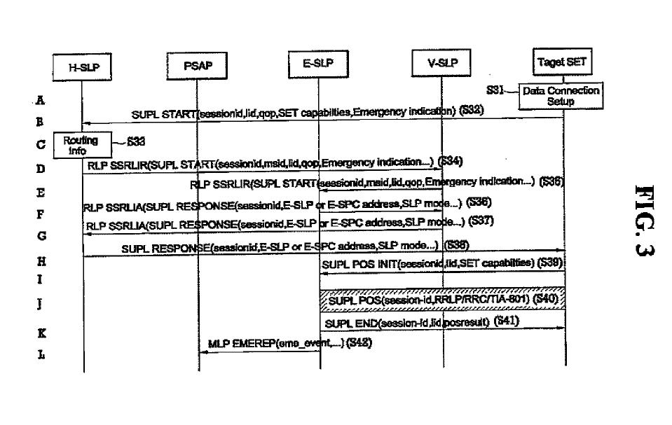

FIG. 3 is a message flowchart illustrating a location service method in accordance with a second embodiment of the present invention, which illustrates an emergency call processing procedure when a target SET is in a roaming state and a connection mode is a proxy mode. Also, the second embodiment illustrates a SET initiated case that a service is initiated from the SET.

As illustrated in FIG. 3, a visited network in which the target SET is currently located should be considered in a roaming state (case). Accordingly, the target SET, H-SLP, V-SLP, and E-SLP take part in an emergency positioning process. In this case, a location service system for providing the target SET with an emergency positioning service may comprise the H-SLP, the V-SLP and the E-SLP which manages an emergency positioning for a visited network.

First, when a data connection has not been set between the target SET and a certain network before requesting an emergency call, the target SET requests a data connection from a packet switches network or a circuit switched network to perform a data connection setup (S31). Here, the network may be a 3GPP or 3GPP2 network.

Upon completely setting the data connection, the target SET sends a SUPL START message including emergency call indication information to the H-SLP to request an emergency positioning (S32).

Here, the SUPL START message may include a session ID (session id) of a SUPL session which is started by the emergency call of the target SET, a location ID (lid) which is a cell ID in which the target SET is currently located, required quality of service (QoS) related information (qop), SET capabilities related information which includes a positioning method supported by the target SET and information related to protocols used for the positioning, emergency call indication information (Emergency indication) indicating that the SUPL START message is an emergency call, and the like. Here, the emergency call indication information may be inserted by adding a field with certain bits to a typical SUPL START message or by designating a field remaining without being used.

When sending the SUPL START message to the H-SLP, the H-SLP retrieves routing information of the target SET to determine whether the target SET is roaming (S33). The second embodiment illustrates a case that the SET is in the roaming state. Accordingly, the H-SLP can determine that the target SET is currently in the roaming sate, namely, is located within an area of a visited network. The H-SLP forwards the sent SUPL START message to the V-SLP via the RLP (S34). That is, the H-SLP sends the SUPL START message to the V-SLP in the format of a RLP SSRLIR message. The V-SLP then forwards the sent RLP SSRLIR message to the E-SLP (S35).

Afterwards, the E-SLP sends to the V-SLP a SUPL RESPONSE message including its address information in the format of the RLP SSRLIA message, in response to the RLP SSRLIR message sent from the V-SLP (S36). The V-SLP forwards the sent RLP SSRLIA message to the H-SLP (S37).

Here, the address information may be an address connectable to the E-SLP, for example, an IP address or a URL address of the E-SLP. Also, for a non-proxy mode, the address information may be an address of the E-SPC. The SUPL RESPONSE message may include a session ID (session id) and connection mode information (SLP mode) in addition to the address information related to the E-SLP. Here, the connection mode information denotes a parameter for discriminating a non-proxy mode and a proxy mode. Also, the SUPL RESPONSE message may further include a positioning method supported by the E-SLP.

Afterwards, the H-SLP receives the SUPL RESPONSE message in the format of the RLP SSRLIA message sent from the V-SLP, and then sends the SUPL RESPONSE message to the targe SET (S38). Hence, the target SET can receive the SUPL RESPONSE message.

The target SET sends a SUPL POS INIT message to the E-SLP using the address of the E-SLP sent by being included in the SUPL RESPONSE message to thus initiate an actual positioning related procedure (S39). Here, for the non-proxy mode, the target SET can send the SUPL POS INIT message to the E-SPC to thusly initiate the positioning related procedure.

The SUPL POS INIT message may include a sesio ID, location ID, SET capabilities related information. The SET capabilities related information, as aforementioned, may include a positioning method supported by the target SET (e.g., SET assisted A-GPS, SET based A-GPS, etc.), protocol information usable for the positioning (e.g., RRLP, RRC or TIA-801), etc.

The E-SLP determines positioning method and related protocol to use in the positioning for the target SET based upon the SET capabilities included in the SUPL POS INIT message received. The E-SLP then consecutively exchanges message with the target SET for the positioning to thereby calculate a location of the target SET (S40).

Upon completely calculating the location information with respect to the target SET, the E-SLP sends the calculated location information (pos result) with respect to the target SET to the target SET using a SUPL END message to inform the termination of the SUPL procedure (S41). The SUPL END message may include a session ID and a location ID as well as the calculated location information for the target SET.

Afterwards, the E-SLP sends emergency event information including the calculated location information to the PSAP via a MLP EMEREP message to request the PSAP to process an emergency condition (S42). Here, the emergency event information included in the MLP EMEREP message, as mentioned in the first embodiment, may include event trigger information, terminal related information and location information with respect to the target SET.

One of the H-SLP, the V-SLP or the E-SLP can approximately calculate a current location of the target SET based upon the location ID included in the SUPL START message sent from the target SET. When the calculated location information satisfies the quality of service qop, the positioning step S40 performed by a consecutive message exchange between the E-SLP and the target SET can be omitted.

For example, the V-SLP approximately calculates a current location value of the target SET using the location ID included in the SUPL START message sent from the H-SLP via the RLP. When the calculated location value satisfies a quality of service required, the V-SLP sends the calculated location value to the E-SLP and then terminates (ends) the SUPL session for the emergency positioning. The E-SLP inserts the location value sent from the H-SLP into the MLP EMEREP message to send it to the PSAP. Accordingly, the V-SLP can requests the PSAP to process the emergency condition.

In another method, the V-SLP forwards the SUPL START message to the E-SLP via the RLP. The E-SLP can thus approximately calculate a current location value of the target SET using the location ID included in the SUPL START message. In this case, if the calculated location value satisfies the quality of service required, the E-SLP includes the calculated location value in the RLP SSRLIA message which informs a session termination (end). The E-SLP then sends the RLP SSRLIA message including the calculated location value to the H-SLP and also sends a MLP EMEREP message including the calculated location value to the PSAP.

Thus, in the second embodiment of the present invention, the explanation has been given of the location service method for the emergency call when the target SET is in the roaming state and the connection mode is the proxy mode. In the second embodiment, the target SET has been connected to the E-SLP via the H-SLP of the home network and the V-SLP of the visited network. However, upon an occurrence of an emergency condition, a direct connection between the target SET and the E-SLP can allow more fast service. Therefore, a location service method which allows a direct connection between the target SET and the E-SLP will now be explained in accordance with a third embodiment.

### Third Embodiment

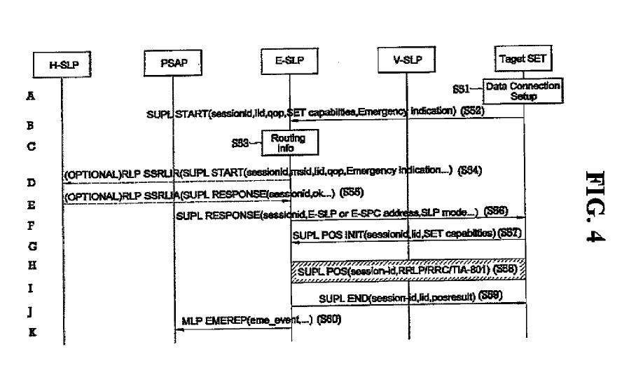

FIG. 4 is a message flowchart illustrating a location service method in accordance with a third embodiment of the present invention, which illustrates an emergency call processing procedure when a target SET is in a roaming state and a connection mode is a proxy mode.

As illustrated in FIG. 4, in the third embodiment, the target SET and the E-SLP take part in an emergency positioning process. Also, the H-SLP can take part therein to manage or authenticate the target SET in some cases.

Here, the E-SLP has a predetermined standardized ID, for example, a domain name such as “emergency.slp@lge.com”. The use of the E-SLP address can allow the target SET to be directly connected to the E-SLP not via the H-SLP. Hence, the target SET should first obtain the address of the E-SLP before requesting the emergency call.

There may be three methods for obtaining the address of the E-SLP by the target SET. The first method is that the target SET obtains the address of the E-SLP by a DNS query.

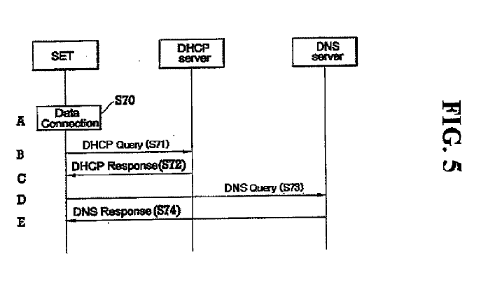

FIG. 5 is a flowchart illustrating a process in which a target SET obtains an E-SLP address by a DNS query.

As illustrated in FIG. 5, first, when any data connection has not been set between the target SET and a certain network, the target SET requests a data connection from a network in which the target SET is currently located to thus be connected to the network (S70).

Afterwards, the target SET sends a Dynamic Host Configuration Protocol (DHCP) query to a DHCP server to request an address of a DNS server therefrom (S71). Additionally, the sent DHCP query may be used to indicate that the corresponding DHCP query is for an emergency call. Then, the DHCP server provides the target SET with the address of the DNS server in response to the query sent from the target SET (S72).

Upon receiving the address of the DNS server, the target SET sends a DNS query to the provided address to request the address of the E-SLP (S73). Here, the target SET may include area information (e.g., cell-id) in which the target SET is located in the DNS query to thereby be allocated the address of the E-SLP located closest to the point where the target SET is positioned. Accordingly, the DNS server responds to the query to send an appropriate address of the E-SLP to the target SET (S74).

A second method for obtaining the address of the E-SLP by the target SET is that the target SET internally generates an address of the E-SLP according to a preset rule. In this case, an actual address of the E-SLP should be pre-designated to be suitable for the address generated by the target SET. Such internal generation method may be divided into a case that a Universal Integrated Circuit Card (UICC) exists within the target SET and a case that the UICC does not exist therein.

First, when the UICC exists in the target SET, the address of the E-SLP can be generated by using an International Mobile Subscriber Identity (IMSI) value.

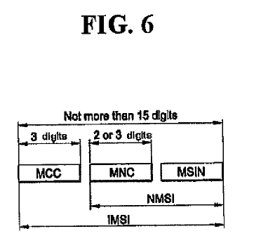

FIG. 6 is an exemplary view illustrating a typical construction of a International Mobile Subscriber Identity (IMSI). As illustrated in FIG. 6, the IMSI may typically include a Mobile Country Code (MCC), a Mobile Network Code (MNC) and a Mobile Subscriber Identification Number (MSIN). Here, the MCC is generally constituted with three bits as a code for identifying a country in which a terminal is located. The MNC is a code for identifying a Home Public Land Mobile Network (HPLMN) of a terminal, which is constituted with two or three bits. The MSIN is a code for identifying a user in a PLMN.

The target SET can configure an E-SLP address based upon values of the MCC and MNC among the IMSI values. For example, the target SET reads out the IMSI values of the UICC mounted therein. According to whether the MNC is constituted with 2 bits or 3 bits, first 5 bits or 6 bits of the IMSI values are extracted to be divided into the MCC and MNC. The extracted MCC and MNC are then used to configure a domain name as follows.

“[mnc+extracted MNC value][mcc+extracted MCC value].pub.3gppnetwork.org”

Also, an element for indicating an emergency positioning, for example, “e-slp” is added in front of the domain name to thus obtain an E-SLP address as follows.

“e-slp. [mnc+extracted MNC value][mcc+extracted MCC value].pub.3gppnetwork.org”

For example, if the IMSI value is “123456789999999”, the MCC value is “123” and the MNC value is “456”. Thus, the E-SLP address generated is likely to be “e-slp. [mnc+456][mcc+123].pub.3gppnetwork.org”.

Meanwhile, if the UICC does not exist in the target SET, the E-SLP address can be configured using MCC value and MNC value which are preset for an emergency call. For example, if the MCC value is set to “119” and the MNC value is set to “119” both of which are preset for the emergency call, the corresponding values are applied to thusly generate the E-SLP address such as “e-slp.[mnc+119][mcc+119].pub.3gppnetwork.org”. Also, if the MCC value and MNC value preset for the emergency call are set even if the UICC exists in the target SET, the MCC value and the MNC value for the emergency call can be used to generate the E-SLP address.

A third method for obtaining an E-SLP address by the target SET is to previously store an E-SLP address in the target SET in a provisioning manner. For example, an E-SLP address predetermined by a roaming area is stored in the target SET. When the target SET requests an emergency call, the target SET can find (retrieve) the address of the E-SLP which manages the emergency positioning of a network, in which the target SET is currently located, thus to be directly connected thereto.

Here, each E-SLP address can be stored in the target SET by employing several methods including a method for storing each E-SLP address in the SET at a time point of the SET being manufactured, a method for updating each E-SLP address stored in the SET by a communication operator or consignment entity during a service provided, a method for storing each E-SLP address in the SET during a service subscribing process, and the like.

As described above, it can be understood the target SET itself can obtain the E-SLP address before initiating the SUPL procedure. Thus, based upon this, the emergency location service procedures as shown in FIG. 4 can be implemented.

Referring to FIG. 4, first, when any data connection has not been set between the target SET and a certain network before requesting an emergency call, the target SET requests a data connection from a packet switched network or a circuit switched network to thus perform a data connection setup (S51).

Here, the target SET can get an address of the E-SLP preset by a DNS query in a format like “emergency.slp@lge.com”. Also, as aforementioned, the E-SLP address may be created in the target SET according to a pre-designated rule, and also be pre-stored in the target SET by each network operator. In these cases, a separate DNS query may not be required.

Upon completely setting the data connection, the target SET sends to the E-SLP a SUPL START message including emergency call indication information to request an emergency positioning (S52).

Here, the SUPL START message may include a session ID (session id) of a SUPL session which is started by the emergency call of the target SET, a location ID (lid) which is a cell ID in which the target SET is currently located, quality of service (QoS) related information (qop) required, SET capabilities related information which includes a positioning method supported by the target SET and information related to protocols used for the positioning, emergency call indication information (Emergency indication) indicating that the SUPL START message is an emergency call, and the like.

In addition, the target SET can send an ID of a home network in which the target SET has been registered by using a HPLMN ID. Here, the E-SLP can assist to find the home network in which the target SET has been registered and the H-SLP.

When the SUPL START message is sent to the E-SLP, the E-SLP retrieves routing information of the target SET to determine whether the target SET is roaming (S53). The third embodiment illustrates when the SET is in the roaming state. Accordingly, the E-SLP can determine that the target SET is currently in the roaming state, namely, is located within the area of the visited network, which means that the E-SLP is not located in the home network of the target SET. Furthermore, the E-SLP determines the home network of the target SET based upon a terminal ID (ms id) of the target SET. Here, when the target SET sends the HPLMN ID, the E-SLP can find the home network more easily based upon the HPLMN ID.

Afterwards, the E-SLP informs the H-SLP of emergency call information of the target SET via the RLP (S54). That is, the E-SLP sends the sent SUPL START message to the H-SLP in a format of the RLP SSRLIR message. The H-SLP informs the E-SLP of the reception of the RLP SSRLIR message by sending the RLP SSRLIA message (S55).

The steps S54 and S55 are not necessarily performed for the emergency call processing procedure. They may rather be performed, for a certain communication operator or a certain country, because of authentication of a home network even if an emergency call is originated. Also, such steps may be performed, for example, to transfer information indicating a particular state of the target SET which has been registered in the home network.

The E-SLP then sends to the target SET a SUPL RESPONSE message including address information with respect to a network entity which is to perform actual positioning for the target SET (S56).

Here, the address information with respect to the network entity may be an address of the E-SLP itself, but be an address of a certain E-SLP if there exists the certain E-SLP (e.g., an E-SLP closer to the target SET than others) which can perform positioning for the target SET more easily. Also, if there exists V-SLP or H-SLP located close to the target SET, in stead of the E-SLP, the address information with respect to the network entity may be an address of the corresponding SLP. If the connection mode is a non-proxy mode, the address information may be the address of the V-SPC or H-SPC as well as the E-SPC.

Therefore, the target SET has already known the address of the initially-connected E-SLP. However, the target SET should first ascertain an address of a network entity provided from the E-SLP for an actual positioning and then access the corresponding address. Here, if the E-SLP has designated another network entity (e.g., V-SLP, H-SLP, or another E-SLP) other than itself, the corresponding network entity should calculate the location information for the target SET to transfer it to the original E-SLP.

In the third embodiment is assumed that the E-SLP performs the actual positioning as illustrated in FIG. 4.

The SUPL RESPONSE message may include a session-ID and connection mode information in addition to the E-SLP address information. Here, the connection mode information denotes a parameter for discriminating a non-proxy mode and a proxy mode. The SUPL RESPONSE message may further include information with respect to a positioning method supported by the E-SLP.

The target SET sends to the E-SLP a SUPL POS INIT message for requesting an initiation of a positioning procedure by using the address of the E-SLP sent through the SUPL RESPONSE message, thereby initiating an actual positioning related procedure (S57). Here, if the connection mode is a non-proxy mode, the target SET may send the SUPL POS INIT message to the E-SPC to initiate the positioning related procedure.

The SUPL POS INIT message may include a session ID, a location ID, SET capabilities related information, and the like. The SET capabilities related information, as aforementioned in the first and second embodiments, may include a positioning method supported by the target SET (e.g., a SET assisted A-GPS or a SET based A-GPS), protocol information usable for positioning (e.g., RRLP, RRC or TIA-801), etc.

The E-SLP determines positioning method and related protocol to be used in the positioning for the target SET based upon the SET capabilities related information included in the received SUPL POS INIT message. The E-SLP then calculates a location of the target SET by a consecutive message exchange with the target SET for the positioning (S58).

Upon completely calculating the location information for the target SET, the E-SLP sends the calculated location information (pos result) for the target SET to the target SET using a SUPL END message thus to inform the target SET of the end (termination) of the SUPL procedure (S59). The SUPL END message may include a session ID and a location ID as well as the calculated location information for the target SET.

Afterwards, the E-SLP sends the calculated location information to the PSAP using a MLP EMEREP message to request the PSAP to process the emergency condition (S60). Here, as illustrated in the first embodiment, the MLP EMEREP message may include event trigger information, terminal related information and the location information for the target SET.

Meanwhile, before performing the positioning for the target SET (S58), the E-SLP approximately calculates the location of the target SET using the location ID of the target SET included in the SUPL POS INIT message received from the target SET. If the calculated location value satisfies required quality of service (QoS) related information (qop) required, the E-SLP includes the calculated location value in the SUPL END message to send to the target SET. In this case, it is not required to perform the positioning for the target SET (S58).

In the above-described third embodiment of the present invention, description has been given of the processing procedure in which the target SET can directly access the E-SLP using the address of the E-SLP which can be obtained by the DNS query or an internal generation, or be pre-stored in the target SET. This third embodiment can implement more efficient location service method in the aspect of the characteristics of the emergency call which should be fast processed.

Also, in the second and third embodiments, since a connection between the E-SLP and a user terminal is available through a series of processes although a user moves into a roaming area, the emergency positioning service based upon a user plane can be implemented. In addition, even if the user is located in an area not existing a roaming agreement, a message sending is allowed in case of an emergency call. Accordingly, the emergency positioning service can be implemented.

The first, second and third embodiments have illustrated the SET initiated case that the SUPL agent exists the target SET and thus the target SET initiates the positioning procedure based upon the SUPL. Therefore, fourth and fifth embodiments will be adapted to explain a location service method for an emergency call in a network initiated case that a network initiates a positioning procedure.

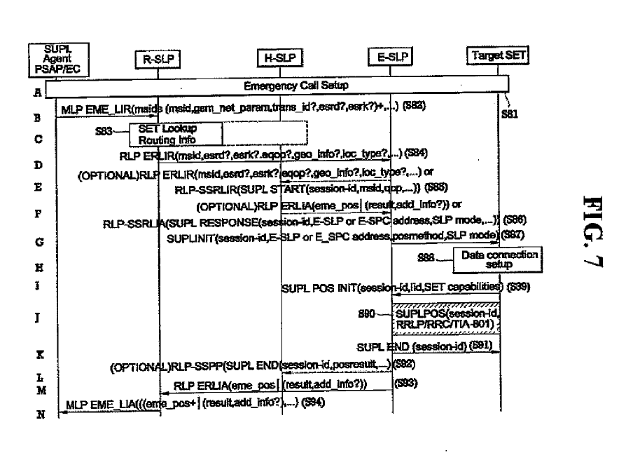

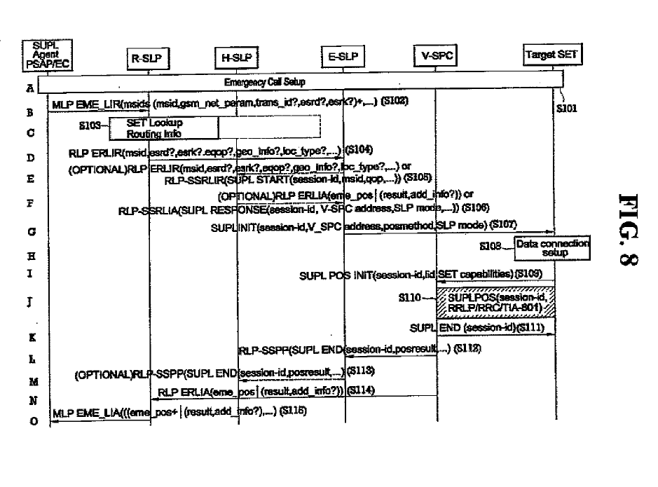

First, referring to fourth and fifth embodiments illustrated in FIGS. 7 and 8, there exist elements having a mark “?” among elements included in messages shown in FIGS. 7 and 8. Here, “?” denotes ‘optional’, namely, elements having “?” may optionally (selectively) be inserted in the corresponding message.

### Fourth Embodiment

FIG. 7 is a message flowchart illustrating a location service method in accordance with a fourth embodiment of the present invention, which illustrates an emergency positioning procedure when a SET is in a non-roaming state and a connection mode is a proxy mode. Also, the fourth embodiment illustrates a network initiated case that a target SET establishes an emergency call with a PSAP or Emergency Center (EC), and thereafter a SUPL agent existing within the PSAP or EC initiates a positioning procedure.

Referring to FIG. 7, since a visited network does not exist in the non-roaming case, target SET, PSAP (or EC, hereafter referred to as the PSAP), R-SLP (Requesting SLP), H-SLP and E-SLP take part in an emergency call processing procedure. Here, the R-SLP denotes a SLP that an external client initially accesses when a SUPL procedure is initiated in a network.

First, the target SET establishes an emergency call with the PSAP (S81). Such emergency call may be established by a voice call through a circuit switched network or a data call through a packet switched network, and also be established by an emergency call application through a Wireless Application Protocol (WAP).

The SUPL agent of the PSAP sends to the R-SLP a MLP EME_LIR (Emergency Location Immediate Request) message for requesting an emergency positioning (S82). Here, the MLP EME_LIR message may include a terminal ID (ms-id) of the target SET, a GSM network parameter (gsm_net_param, for use of the GSM), a transaction ID (trans_id), an ESRD (Emergency Service Routing Digits), an ESRK (Emergency Service Routing Key), and the like.

Here, the transaction ID denotes an ID for discriminating each of plural positioning requests by the same target SET. The ESRD denotes a type of management code for identifying an area in which an emergency call is sent. The ESRK denotes a management code used in identifying the PSAP.

In addition, the MLP EME_LIR message may further include required quality of service (QoS) related information (qop), location information (geo_info) of a location server, location type information (loc_type), push address information (pushaddr), and the like. Here, the location type information denotes information for identifying whether location information provided is current information, last information, or initial information. For example, the location type information can have values such as “current”, “last”, “last or current”, “current or last”, “initial”, etc. The push address information denotes an address for providing location information in a pushing manner. For example, a domain name may be the push address.

Upon sending the MLP EME_LIR message to the R-SLP, the R-SLP itself accesses a Home Location Register (HLR) or Home Subscriber Server (HSS) of a home network in which the target SET has been registered. The R-SLP then determines whether the target SET is currently (SUPL) roaming and whether the target SET can support the SUPL (S83). Here, the R-SLP can be cooperated with the H-SLP via an internal communication to retrieve routing information with respect to the target SET or a lookup table of the target SET. Also, in this step, the R-SLP can find an E-SLP existing in a network to which the target SET currently belongs.

Afterwards, the R-SLP sends to the E-SLP a RLP ERLIR (Emergency Roaming Location Immediate Request) message (S84). Here, the RLP ERLIR message may include a terminal ID (ms-id) and additionally include ESRD, ESRK, required quality of service (QoS) related information (qop), location information (geo_info) of a location server, location type information (loc_type), etc.

The E-SLP forwards the RLP ERLIR message sent from the R-SLP to the H-SLP, or sends a SUPL START message to the H-SLP using a RLP SSRLIR message (S85). The H-SLP sends to the E-SLP a RLP ERLIA (Emergency Roaming Location Immediate Answer) message or a SUPL RESPONSE message through a RLP SSRLIA message, in response to the RLP ERLIR message or SUPL START message (S86).

The steps S85 and S86 are not necessarily performed for the emergency call processing procedure. They may rather be performed, for a certain communication operator or a certain country, because of authentication of a home network even if an emergency call is originated. Also, such steps may be performed, for example, to transfer information indicating a particular state of the target SET which has been registered in the home network.

The E-SLP then sends a SUPL INIT message to the target SE (S87). Here, the SUPL INIT message may include a session ID (session id), a positioning method to be used (posmethod), an address of a network entity to perform positioning and connection mode information (SLP mode). Here, the address of the network entity may be the address of the E-SLP, or be an address of E-SPC for a non-proxy mode. Here, a connection mode identification parameter can be used to identify whether the address of the network entity is an address in a proxy mode or in a non-proxy mode.

Furthermore, the SUPL INIT message may further include indication information informing that the corresponding SUPL session is related to an emergency call. The emergency call indication information can be inserted by adding a field with certain bits to a typical SUPL START message or by designating a field remaining without being used.

When a data connection has not been set between the target SET and a certain network, the target SET having received the SUPL INIT message requests a data connection from a packet switched network or a circuit switched network to perform a data connection setup (S88). Here, the network may be 3GPP or 3GPP2 network.

Upon completing the data connection setup, the target SET sends a SUPL POS INIT message to an address provided by the SUPL INIT message to initiate an actual positioning related procedure (S89). For a non-proxy mode, the target SET can initiate the positioning related procedure by sending the SUPL POS INIT message to the E-SPC. Here, the SUPL POS INIT message may include a session ID, a location ID and SET capabilities related information.

The E-SLP determines positioning method and related protocol to be used in the positioning for the target SET based upon the SET capabilities related information included in the received SUPL POS INIT message. The E-SLP then calculates a location of the target SET by a consecutive message exchange with the target SET for the positioning (S90).

Upon completely calculating the location information for the target SET, the E-SLP sends a SUPL END message to the target SET to notify the target SET of the end (termination) of the SUPL procedure for the positioning (S91). If necessary, the E-SLP may send the SUPL END message to the H-SLP using a RLP SSRP (Standard SUPL Roaming Position) message (S92). Here, the SUPL END message may include the calculated location information (pos result) for the target SET.

The E-SLP also sends a RLP ERLIA (Emergency Roaming Location Immediate Answer) message to the R-SLP (S93). Here, the RLP ERLIA message may include the calculated location information (eme_pos or result, add_info) for the target SET. The R-SLP sends a MLP EME_LIA to the PSAP to notify the PSAP of the positioning result (S94). Hence, the PSAP can receive the location information for the target SET having urgently requested (i.e., with respect to the emergency call or condition) through the series of processes.

### Fifth Embodiment

FIG. 8 is a message flowchart illustrating a location service method in accordance with a fifth embodiment of the present invention, which illustrates an emergency positioning procedure when a target SET is in a roaming state and a connection mode is a non-proxy mode.

When the target SET is in the roaming state in a network initiated case, a V-SLP or V-SPC of a visited network in which the target SET is currently located can take part in the emergency positioning procedure, or not take part therein. For example, in case that the E-SLP exists in a visited network and the E-SLP is located in a position closest to the target SET, the V-SLP does not have to participate in the emergency positioning procedure. However, in case that the E-SLP does not exist in the visited network or the V-SLP is located in a position closer to the target SET than the E-SLP is event if the E-SLP exists in the visited network, the V-SLP or V-SPC may participate in the positioning procedure.

Turning to FIG. 8, in the fifth embodiment, target SET, PSAP (or ECO, R-SLP, H-SLP and E-SPC take part in the emergency call processing procedure.

First, the target SET establishes an emergency call with the PSAP (S101). Thereafter, the same steps, as illustrated in the fourth embodiment, corresponding to sending the MLP EME_LIR message by the SUPL agent existing in the PSAP (S102) through sending the RLP ERLIA (or RLP SSRLIA) message by the H-SLP (S106), are performed.

However, when the V-SLP of the visited network is located in a position closer to the target SET than the E-SLP is, the E-SLP informs the target SET of the address of the V-SLP by sending the SUPL INIT message including the address information thus to allow the V-SLP to perform the positioning. However, the fifth embodiment illustrates the case of the non-proxy mode. Accordingly, the address information included in the SUPL INIT message sent to the target SET may be the address of the V-SPC (S107). Here, the SUPL INIT message may include connection mode information (SLP mode) to indicate that the connection mode is the non-proxy mode. The SUPL INIT message may further include a session ID, a positioning method to be used, protocol information to be used for the positioning, emergency call indication information, etc.

When a data connection has not been set between the target SET and a certain network, the target SET having received the SUPL INIT message requests a data connection from a packet switched network or a circuit switched network to perform a data connection setup (S108).

Upon completing the data connection setup, the target SET sends a SUPL POS INIT message to the V-SPC address provided by the SUPL INIT message to initiate an actual positioning related procedure (S109). Here, the SUPL POS INIT message may include a session ID, a location ID and SET capabilities related information.

The V-SPC determines positioning method and related protocol to be used in the positioning for the target SET based upon the SET capabilities related information included in the received SUPL POS INIT message. The V-SPC then calculates a location of the target SET by a consecutive message exchange with the target SET for the positioning (S110).

Upon completely calculating the location information for the target SET, the V-SPC sends a SUPL END message to the target SET to notify the target SET of the end (termination) of the SUPL procedure for the positioning (S11). Afterwards, the V-SPC sends the SUPLE END message to the E-SLP using a RLP SSRP (Standard SUPL Roaming Position) message (S112). Here, the SUPL END message may include session ID, the calculated location information (pos result) for the target SET, etc.

The E-SLP sends a RLP ERLIA message to the R-SLP (S114). The R-SLP sends a MLP EME_LIA message to the PSAP to notify the PSAP of the positioning result (S115). Thus, the PSAP can receive the location information for the target SET having urgently requested through the series of steps. The E-SLP, if necessary, can forward the RLP SSRP message sent from the V-SPC to the H-SLP (S113).

As described in the embodiments of the present invention, it can be apparent to those skilled in the art that various modifications and variations are available within the range of scope and spirits of the present invention disclosed in the claims hereafter. Therefore, it can be understood that the variations or modifications of the embodiments of the present invention may not be apart from the scope of the present invention.

### EFFECT OF THE INVENTION

As described above, the present invention can provide an emergency positioning service based upon SUPL communication protocols which are applicable to commonly used networks. Hence, an emergency call which has not been considered in the SUPL can be processed. In addition, a direction connection between a target SET and an E-SLP which can provide an emergency location service can be allowed thus to provide a fast location service for the emergency call.

1. A location service method using a location service system based upon a user plane, the method comprising:
receiving an emergency positioning request message from a target terminal; and
sending to the target terminal a message including address information on a network entity which is to perform an emergency positioning for the target terminal and connection mode information, in response to the received emergency positioning request message.

2. The method of claim 1, wherein the address information is either an address of an E-SLP (Emergency SUPL Location Platform) or an address of an E-SPC (Emergency SUPL Positioning Center) provided in the E-SLP to calculate actual location information.

3. The method of claim 2, wherein the connection mode information is information used to identify a non-proxy mode in which a direct communication is available between the target terminal and the E-SPC, and a proxy mode in which a communication between the target terminal and the E-SPC is available via an E-SLC (Emergency SUPL Location Center) within the E-SLP.

4. The method of claim 3, wherein the address information is the E-SPC address when the connection mode information indicates the non-proxy mode, while the address information is the E-SLP when the connection mode indicates the proxy mode.

5. The method of claim 1, further comprising calculating location information regarding the target terminal by a consecutive message exchange between the network entity and the target terminal when the network entity receives a message for requesting a positioning initiation from the target terminal.

6. The method of claim 5, further comprising sending the location information calculated by the network entity to either the target terminal or an emergency condition processing center located at a position close to the target terminal.

7. A location service method using a location service system based upon a SUPL (Secure User Plane Location), the method comprising:
receiving in an E-SLP a SUPL START message including emergency call indication information regarding a target terminal; and
sending, by the E-SLP, a SUPL RESPONSE message including connection information on a network entity to perform an emergency positioning for the target terminal, in response to the sent SUPL START message.

8. The method of claim 7, wherein the SUPL START message received in the E-SLP is a message that is first generated from the target terminal, then initially received by a H-SLP (Home-SUPL Location Platform), and finally sent to the E-SLP.

9. The method of claim 8, receiving the SUPL START message comprises:
receiving in the H-SLP the SUPL START message sent from the target terminal;
retrieving routing information of the target terminal, by the H-SLP, to determine whether the target terminal is currently roaming; and
sending the received SUPL START message to a V-SLP (Visited SUPL Location Platform) when it is determined that the target terminal is roaming, and sending the received SUPL START message to an E-SLP of a home network when it is determined that the target terminal is not roaming.

10. The method of claim 9, wherein sending the SUPL RESPONSE message when the target terminal is not roaming or not in a roaming state, comprises;
sending the SUPL START message from an E-SLP of a home network to the H-SLP; and
sending the sent SUPL START message from the H-SLP to the target terminal.

11. The method of claim 9, wherein the V-SLP sends the sent SUPL START message to the E-SLP of the visited network.

12. The method of claim 7, wherein sending the SUPL RESPONSE message comprises:
sending the SUPL RESPONSE message to the V-SLP by the E-SLP of the visited network;
sending the sent SUPL RESPONSE message from the V-SLP to the H-SLP; and
sending the sent SUPL RESPONSE message from the H-SLP to the target terminal.

13. The method of claim 7, wherein the SUPL START message received in the E-SLP is a message directly sent from the target terminal.

14. The method of claim 13, further comprising:
retrieving routing information of the target terminal, by the E-SLP, to determine the H-SLP when receiving the SUPL START message from the target terminal;
sending the received SUPL START message from the E-SLP to the determined H-SLP thus to inform the H-SLP of emergency call information requested by the target terminal; and
sending the SUPL REPONSE message from the H-SLP to the E-SLP to inform the successful reception of the SUPL START message.

15. The method of claim 14, wherein the H-SLP performs authentication for the target terminal as the SUPL START message is received.

16. The method of claim 7, wherein the SUPL START message and the SUPL RESPONSE message sent among the E-SLP, H-SLP and V-SLP are sent in a format of a RLP (Roaming Location Protocol).

17. The method of claim 7, wherein the connection information is address information of the network entity and connection mode information.

18. The method of claim 17, wherein the address information of the network entity is either an address of the E-SLP or an address of an E-SPC provided in the E-SLP.

19. The method of claim 17, wherein the address information of the network entity is either an address of the SLP or an address of a SPC provided in the SLP in case that there exists the SLP which is located in a position closer to the target terminal as compared with the E-SLP.

20. The method of claim 17, wherein the connection mode information is information for discriminating a non-proxy mode and a proxy mode.

21. The method of claim 7, further comprising calculating location information regarding the target terminal by a consecutive message exchange between the network entity and the target terminal when receiving a SUPL POS INIT message for requesting an initiation of the emergency positioning from the target terminal.

22. The method of claim 21, further comprising:
sending a SUPL END message including the calculated location information from the network entity to the target terminal when completely calculating the location information; and
sending, by the network entity, an emergency message including the calculated location information to an emergency condition processing center located close to the target terminal.

23. The method of claim 22, wherein the emergency message is a MLP (Mobile Location Protocol) EMEREP (Emergency Location Report) message.

24. The method of claim 22, wherein the network entity sends the SUPL END message to the E-SLP when the network entity is different from the E-SLP.

25. The method of claim 7, wherein the emergency call indication information is information for identifying whether the SUPL START message is a message related to an emergency call or a message related to a general location service request, and is inserted in a certain field of the SUPL START message.

26. The method of claim 25, wherein the emergency call indication information is inserted in the field in an active/not-active format.

27. The method of claim 25, wherein the SUPL START message is determined, according to an existence of a value inserted in the field, whether to be the message related to the emergency call or the message related to the general location service request.

28. The method of claim 7, wherein the SUPL START message includes cell information in which the target terminal is currently located and information on quality of service with respect to location information requested.

29. The method of claim 28, wherein one of the E-SLP and the SLP sending the SUPL START message converts the cell information into location information.

30. The method of claim 29, wherein the E-SLP sends the converted location information to at least one of the target terminal and the emergency condition processing center located close to the target terminal when the converted location information satisfies the quality of service.

31. A location service method using a terminal supportable for a SUPL service, the method comprising:
obtaining address information regarding an E-SLP to which an emergency call is to be sent;
sending a SUPL START message including emergency call indication information to the E-SLP using the obtained address information;
receiving from the E-SLP a SUPL RESPONSE message including connection information of a network entity which is to perform an emergency positioning; and
accessing the network entity using the connection information and sending a message related to the positioning requested by the network entity.

32. The method of claim 31, wherein the obtaining of the address information is to obtain the address information by querying an address of the E-SLP to a DNS (Domain Name System) server.

33. The method of claim 32, wherein the terminal queries a DHCP (Dynamic Host Configuration Protocol) server to obtain the address of the DNS server.

34. The method of claim 31, wherein the obtaining of the address information is to obtain the address information pre-stored in the terminal in a provisioning manner.

35. The method of claim 34, wherein the address information stored in the terminal is stored by adapting one of a method for storing address information at a time point of the terminal being manufactured, a method for updating address information through a communication network from an external entity, and a method for storing address information during a service subscribing process of the terminal.

36. The method of claim 31, wherein the obtaining of the address information is to generate the address information in the terminal based upon a fixed rule using preset code information.

37. The method of claim 31, wherein the obtaining of the address information is to generate the address in the terminal based upon a fixed rule using specific information of the terminal.

38. The method of claim 37, wherein the specific information is an IMSI (International Mobile Subscriber Identity) value existing within a UICC (Universal Integrated Circuit Card) of the terminal.

39. The method of claim 38, wherein obtaining the address information comprises:
reading out the IMSI value from the UICC;
extracting certain bits from the IMSI value to divide the extracted certain bits into a MCC (Mobile Country Code) value and a MNC (Mobile Network Code) value; and
configuring a domain address of the E-SLP based upon a fixed rule using the divided MCC value and MNC value.

40. The method of claim 39, wherein obtaining the address information further comprises:
adding identification information indicating an entity for an emergency call to the configured domain address.

41. A location service method using a SUPL based location service system comprising:
receiving an emergency positioning request with respect to a target terminal from a SUPL agent;
sending the received emergency positioning request to an E-SLP; and
sending, from the E-SLP to the target terminal, a SUPL INIT message including connection information of a network entity which is to perform the emergency positioning with respect to the target terminal.

42. The method of claim 41, wherein the SUPL agent exists within an emergency condition processing center.

43. The method of claim 41, wherein the emergency positioning request sent from the SUPL anent is received by a R-SLP (Roaming SLP).

44. The method of claim 43, wherein the emergency positioning request sent from the SUPL anent is a MLP EME_LIR (Emergency Location Immediate Request) message.

45. The method of claim 43, sending the emergency positioning request comprises:
retrieving routing information of the target terminal, by the R-SLP, to determine whether the target terminal is currently roaming; and
sending the emergency positioning request to an E-SLP of a visited network in which the target terminal is located when it is determined that the target terminal is roaming, and sending the emergency positioning request to an E-SLP of a home network in which the target terminal has been registered.

46. The method of claim 45, wherein the R-SLP accesses a HLR (Home Location Register) and a HSS (Home Subscriber Server) of the home network to determine whether the target terminal is roaming.

47. The method of claim 45, wherein the R-SLP retrieves at least one of routing information of the target terminal and a lookup table of the target terminal via an internal communication with the H-SLP.

48. The method of claim 45, wherein the emergency positioning request sent from the R-SLP to the E-SLP is a RLP ERLIR (Emergency Roaming Location Immediate Request) message.

49. The method of claim 45, wherein the E-SLP sends the emergency positioning request sent from the R-SLP to the H-SLP, and the H-SLP sends a response message with respect to the emergency positioning request to the E-SLP.

50. The method of claim 49, wherein the H-SLP receives the emergency positioning request sent from the R-SLP to perform authentication for the target terminal.

51. The method of claim 49, wherein the emergency positioning request sent from the E-SLP to the H-SLP is either a SUPL START message in a format of a RLR ERLIR message or a SUPL START message in a format of a RLP SSRLIR (Standard SUPL Roaming Location Immediate Request) message.

52. The method of claim 51, wherein the response message sent from the H-SLP to the E-SLP is either a SUPL RESPONSE message in a format of a RLR ERLIA (Emergency Roaming Location Immediate Answer) message or a SUPL RESPONSE message in a format of a RLP SSRLIA (Standard SUPL Roaming Location Immediate Answer) message.

53. The method of claim 41, wherein the connection information of the network entity includes address information regarding the network entity and connection mode information.

54. The method of claim 53, wherein the address information regarding the network entity is either an address of the E-SLP or an address of an E-SPC provided in the E-SLP.

55. The method of claim 53, wherein the address information regarding the network entity is either an address of a SLP or an address of a SPC provided in the SLP in case that there exists the SLP located closer to the target terminal as compared with the E-SLP.

56. The method of claim 53, wherein the connection mode information is information for identifying a non-proxy mode and a proxy mode.

57. The method of claim 41, further comprising calculating location information regarding the target terminal by a consecutive message exchange between the network entity and the target terminal when receiving a SUPL POS INIT message for requesting an initiation of the emergency positioning from the target terminal.

58. The method of claim 57, further comprising:
sending a SUPL END message including the calculated location information from the network entity to the target terminal when completely calculating the location information; and
sending, by the network entity, an emergency message including the calculated location information to an emergency condition processing center located close to the target terminal.

59. The method of claim 58, further comprising sending the SUPL END message from the network entity to the E-SLP when the network entity is different from the E-SLP.

60. The method of claim 59, wherein the E-SLP sends the sent SUPL END message to the H-SLP.

61. The method of claim 58, wherein sending the emergency message comprises:
sending a RLP ERLIA message including the calculated location information from the network entity to the R-SLP; and
converting, by the R-SLP, the received RLP ERLIA message into a MLP EME_LIA (Emergency Location Immediate Answer) message to sent to the SUPL agent.

62. A location service system comprising:
at least one SLP for sending an emergency positioning request message by detecting a network in which a target terminal is located when receiving the emergency positioning request message with respect to the target terminal; and
an E-SLP for providing the target terminal with connection information required for the positioning for the target terminal, in response to the emergency positioning request message sent from the at least one SLP.

63. The system of claim 62, wherein the E-SLP has a standardized specific address.

64. The system of claim 63, wherein the target terminal is able to send a SUPL START message including emergency call indication information to the E-SLP using the address of the E-SLP.

65. The system of claim 62, wherein the SLP and the E-SLP are communicated with each other using RLP messages.

66. The system of claim 62, wherein the E-SLP exists in the SLP.
